(19) United States
(12) Patent Application Publication
(10) Pub. No.: US 2006/0156319 A1
(43) Pub. Date: Jul. 13, 2006

(54) Structure of multiple optical disk drive and method of controlling changing disks

(76) Inventor: Jui-Chiang Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/324,274

(22) Filed: Jan. 4, 2006

(30) Foreign Application Priority Data
Jan. 7, 2005 (TW) 094100550

(51) Int. Cl. G11B 17/04; G11B 17/03

(52) U.S. Cl. 720/639

(57) ABSTRACT

A data storage apparatus and a processing method are provided, and more particularly to a data storage apparatus and a processing method thereof which ensure processing safety when changing data storage media. It mainly selectively set a locking mechanism on an up-down mechanism or disk loading/unloading mechanism, which locks after the up-down mechanism arrives at the position or before the disk loading/unloading mechanism loads a tray. After the disk loading/unloading mechanism unloads the tray or before the up-down mechanism moves to a next predefined position, a locking status is unlocked. Thereby, the processing safety will be ensured when changing multiple data storage media, and failures will be prevented occurring because of external force attacking or other vibrations.

### FIELD OF THE INVENTION

The present invention is related to a data storage apparatus and a processing method thereof, and more particularly to a data storage apparatus and a processing method thereof, which ensure processing safety when changing data storage media.

### BACKGROUND

In the process of the storage media, optical disks have outstanding advantages of storing a large amount of data over various storage media. By using optical disks, it not only is more convenient to utilize data, but also helps users carry. Therefore, optical disks are a kind of necessary storage medium nowadays.

Now, it comes an era of information exploding, it is common to own multiple optical disks. Therefore, the owners of the optical disks all wish to have an optical disk drive capable of putting multiple optical disks simultaneously to select and read any time. Therefore, multiple optical disk drives are produced.

A structure of a prior art multiple optical disk drive is shown in FIG. 2. The optical disk drive 10 mainly comprises a magazine 12. A plurality of trays 121 capable of carrying optical disks are set in the magazine 12. An up-down mechanism 14 is further set. A disk loading/pulling mechanism 16 and a reading mechanism 18 are carried on the up-down mechanism 14. Therein, the reading mechanism 18 has further a locking mechanism 185. It can lock at a position opening 15, which reads the optical disk 125 embedded into the optical disk drive 10. Thereby, the stability of operating the reading mechanism 18 will be ensured.

The processing flow of loading/unloading and reading optical disks is shown in FIG. 3. First, at step 201, move the disk pulling mechanism and reading mechanism carried by the up-down mechanism to a position of the optical disk to be read. Then, use the disk pulling mechanism to load the optical disk by the tray carrying the optical disk to be read 203. Next, the reading mechanism holds the optical disk 205. Then the locking mechanism set on the reading mechanism is used to embed the position opening to lock such that the reading mechanism can read data at a more stable status 207. After completing reading data, stop the action of reading, and unlock the locking status of the locking mechanism to loose the reading mechanism 209.

If data of another optical disk is needed to be read, then the up-down mechanism is again used to move the disk pulling mechanism and reading mechanism to a position of a next optical disk to be read 211. Next, perform step 203 and the following steps to form a cyclic flow of reading data.

Although the previous mentioned structure of the prior art optical disk mechanism can achieve the function of selecting and reading multiple optical disks, the locking mechanism 185 is set on the reading mechanism 18, it is only locked when the disk pulling mechanism 16 completely loading the tray 121 and the optical disk 125 and the reading mechanism 18 holds the optical disk and performs the action of reading, and it is unlocked after finishing reading and before unloading the optical disk and the tray. In other words, only when reading data, the whole system is locked. However, in the step of the disk pulling mechanism loading or unloading optical disk and tray, the whole linked system does not have stable enough support. This way, when performing the step of loading or unloading the optical disk and tray, because of the effect of external force attacking or the vibration of the mechanism, the instability of the system will cause the failure of loading or unloading of the optical disk and tray. More seriously, the disk will be stuck because of shifting such that the system will be in a failure status of unable to continue acting.

### SUMMARY OF THE INVENTION

Accordingly, how to design a data storage apparatus and a processing method thereof which not only is benefit to select and access multiple data storage media but also prevent failures occurring because of vibrations against the shortcomings of the previous mentioned prior art multiple optical disk drive is the key point of the present invention. Therefore,

It is a primary object of the present invention to provide a data storage apparatus mainly has a locking mechanism set on an up-down mechanism which locks after the up-down mechanism reaching the position to prevent failures due to external force attacking or mechanical vibrations.

It is a secondary object of the present invention to provide a data storage apparatus. Its locking mechanism can also be set on the disk loading/unloading mechanism which locks before the disk loading/unloading mechanism loading to prevent failures during loading the data storage media and trays because of external force attacking or vibrations.

It is another object of the present invention to provide a processing method of a data storage apparatus. It locks after the up-down mechanism arrives in the position and before performing the action of loading the data storage media to prevent failures caused by attacking or vibrations.

It is another object of the present invention to provide a processing method of a data storage apparatus. It makes the locking mechanism unlock the locking status after completing the action of unloading the data storage media and trays to ensure the stability of the action of unloading disks.

To achieve the previous mentioned objects, the present invention provides a data storage apparatus whose main structure comprising: a magazine, a plurality of trays set therein capable of carrying a plurality of data storage media; a disk loading/unloading mechanism for loading and unloading one of the trays of the magazine; an accessing mechanism for selectively perform one of the actions of reading, writing, and one of the combination thereof to the data storage media loaded by the disk loading/unloading mechanism; and an up-down mechanism for carrying and moving the disk loading/unloading mechanism and the accessing mechanism and capable of moving them to a position accessing the data storage media; wherein the up-down mechanism has further a locking mechanism capable of locking and positioning the up-down mechanism when it reaches the position and then performing actions of loading disks and accessing data. Furthermore, the present invention further provides a data storage apparatus whose main structure comprising: a magazine, a plurality of trays set therein capable of carrying a plurality of data storage media; a disk loading/unloading mechanism for pulling out and unloading one of the trays of the magazine thereby loading and unloading the data storage media; an accessing mechanism for selectively perform one of the actions of reading, writing, and one of the combination thereof to the data storage media loaded by the disk loading/unloading mechanism; and an up-down mechanism for carrying and moving the disk loading/unloading mechanism and the accessing mechanism and capable of moving them to a position accessing the data storage media; wherein the disk loading/unloading mechanism has further a locking mechanism capable of locking and positioning the up-down mechanism when it reaches the position and then performing actions of loading disks and accessing data.

The present invention further provides a processing method of a data storage device wherein the main structure of the data storage apparatus comprises: a magazine using a plurality of trays to carry a plurality of data storage media, a disk loading/unloading mechanism, an accessing mechanism, an up-down mechanism, and a locking mechanism; the processing method mainly comprising the steps of: using the up-down mechanism to move the disk loading/unloading mechanism, accessing mechanism, and locking mechanism to a default position corresponding to the data storage medium to be read; using the locking mechanism to lock the up-down mechanism, accessing mechanism, and disk loading/unloading mechanism to the default position; and using the disk loading/unloading mechanism to pull out a corresponding tray of the magazine to load the data storage medium, and using the accessing mechanism to perform one of the actions of reading, writing, and a combination thereof to the data storage medium.

### BRIEF DESCRIPTION OF DRAWINGS

FIG. 1 is a stereoscopic diagram of a preferred embodiment of the present invention;

FIG. 2 is a profile view of a structure of a prior art optical disk drive;

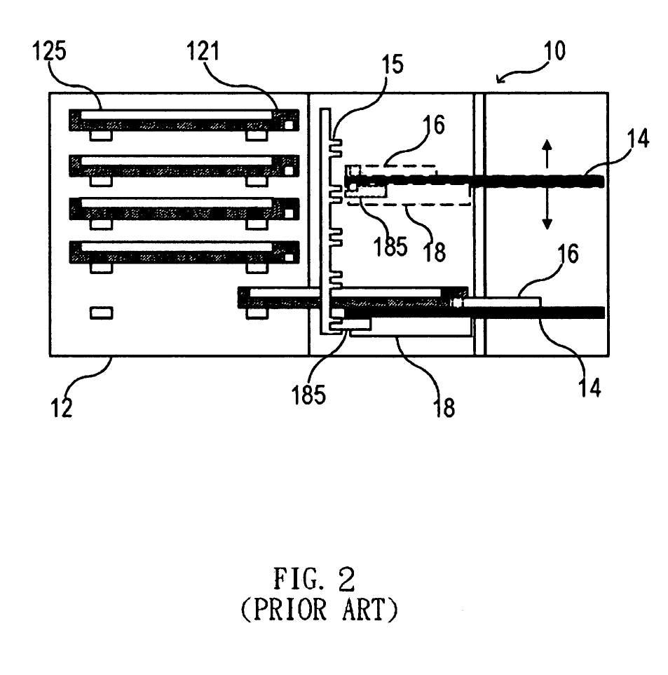

FIG. 3 is a flow chart of operating the prior art optical disk drive;

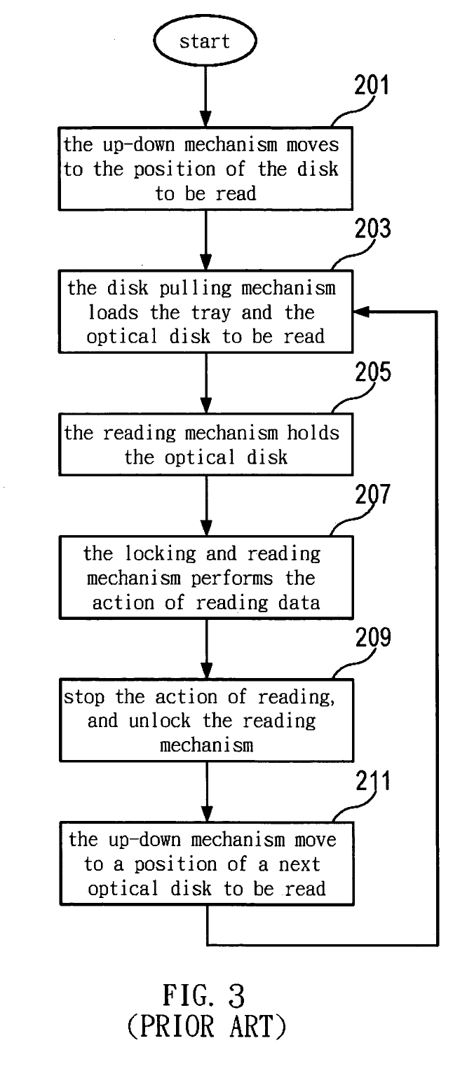

FIG. 4 is a profile diagram of a structure of a preferred embodiment of the present invention;

FIG. 5 is a flow chart of a processing method of the present invention; and

FIG. 6 is a profile diagram of a structure of another preferred embodiment of the present invention.

### DETAILED DESCRIPTION

The structural features and the effects to be achieved may further be understood and appreciated by reference to the presently preferred embodiments together with the detailed description.

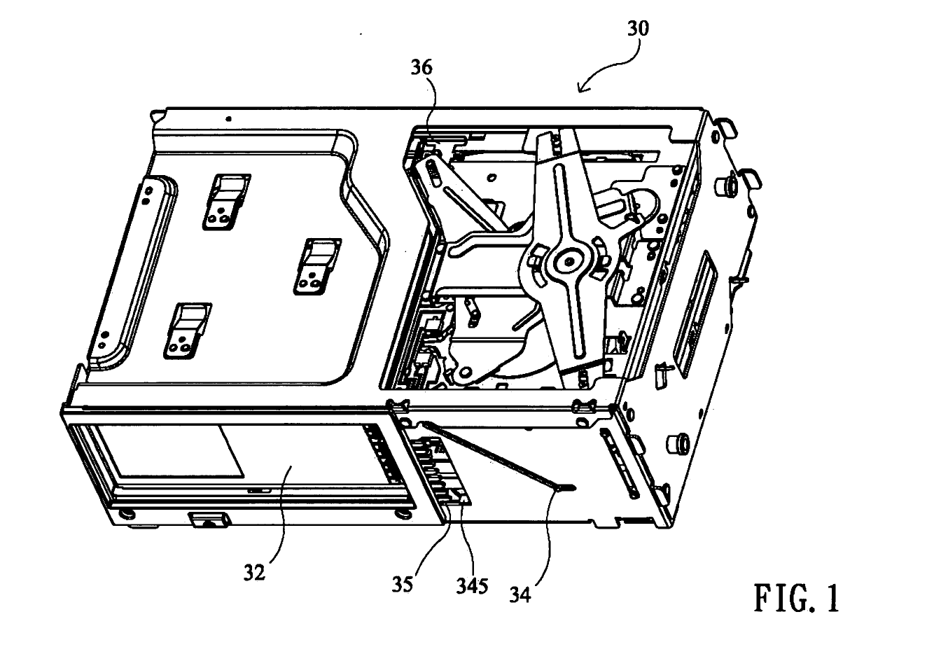

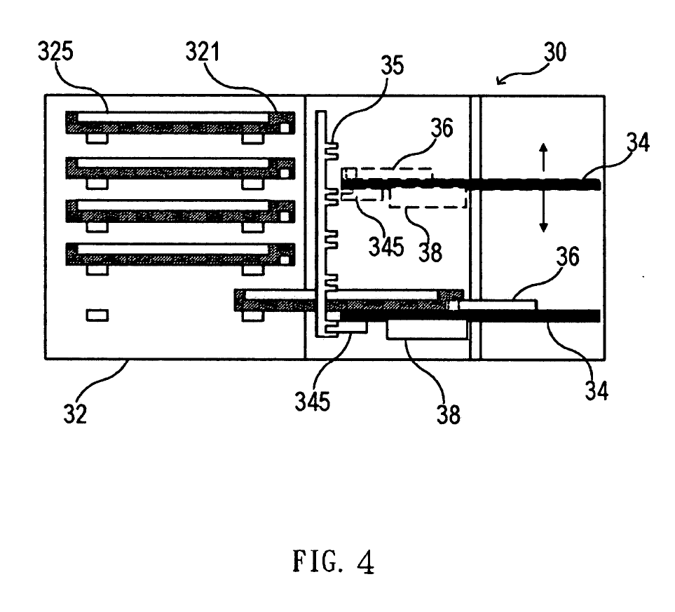

Firstly, refer to FIG. 1 and FIG. 4 respectively, a stereoscopic diagram and profile diagram of a structure of a preferred embodiment of the present invention. As shown, a data storage apparatus 30 of the present invention mainly comprises a magazine 32, a disk loading/unloading mechanism 36, an accessing mechanism 38, and an up-down mechanism 34. Therein, a plurality of trays 321 are set in the magazine 32. Each tray 321 can respectively carry a data storage media 325.

The disk loading/unloading mechanism 36 and the accessing mechanism 38 are respectively set on the up-down mechanism 34. By raising and falling the up-down mechanism 34, the disk loading/unloading mechanism 36 and the accessing mechanism 38 are moved to positions corresponding to the data storage media 325 to be accessed. The disk loading/unloading mechanism 36 is used to pull out the tray 321 to load the data storage media 325, and then the accessing mechanism 38 is used to read or write data.

In the present embodiment, a locking mechanism 345 is set on the up-down mechanism 34 which can be in a locking status of embedding the position opening 35 set on the body after the up-down mechanism 34 arrives position thereby ensuring the following disk loading/unloading and the stability of accessing data.

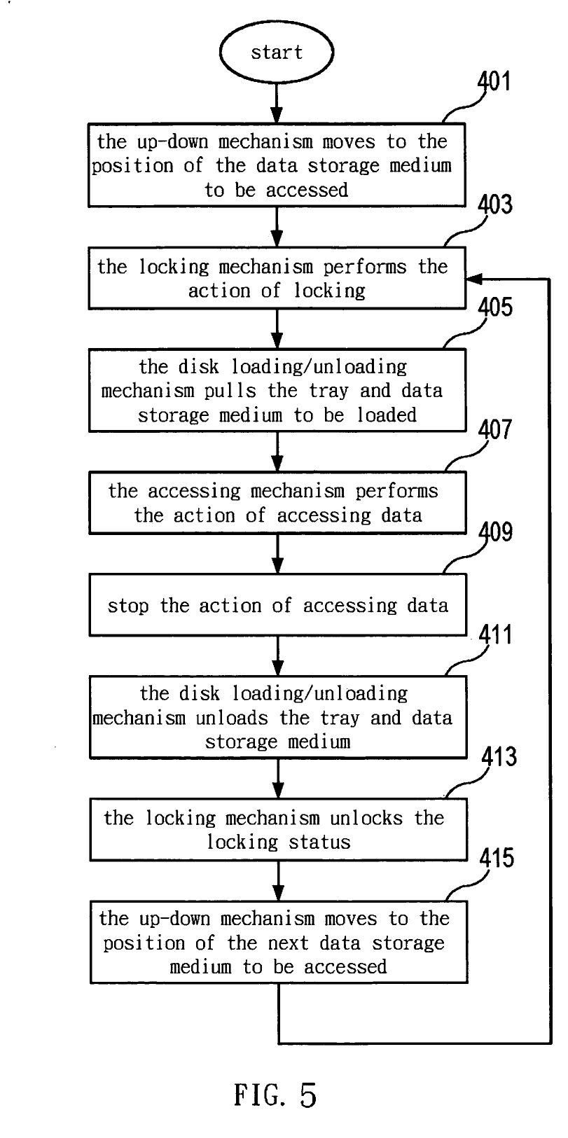

Next, refer to FIG. 5, a flow chart of a processing method of the present invention. As shown, the processing method of the data storage apparatus of the present invention mainly comprises the steps of: first, using the up-down mechanism to move the disk loading/unloading mechanism and the reading mechanism which are carried thereon to a default position of the data storage media whose data is to be accessed 401; embedding the locking mechanism set on the up-down mechanism into the position opening set on the body of the data storage apparatus to perform locking 403; then using the disk loading/unloading mechanism to pull the tray carrying the data storage medium to be read thereby loading the data storage medium 405; next, using the accessing mechanism to perform reading or writing data 407.

After completing accessing data, first, stop accessing data 409; using the disk loading/unloading mechanism to unload the data storage medium as well as the tray back to the original position in the magazine 411; then making the locking mechanism in the up-down mechanism to unlock the locking status 413. Till such a step, a cycle of accessing data is completed.

If another data storage medium is to be accessed, then the up-down mechanism is used to move the disk loading/unloading mechanism and accessing mechanism to a position of the tray carrying a next predefined data storage medium to be accessed 415; next, perform step 403 and its following disk loading/unloading and data accessing actions to form cyclic steps of selecting and changing the data storage media.

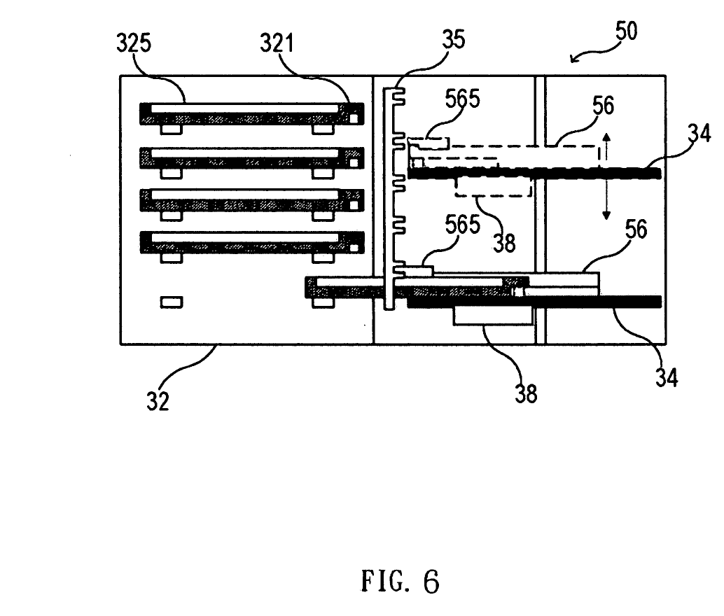

Finally, refer FIG. 6, a profile diagram of a structure of another preferred embodiment of the present invention. As shown, the main structure is generally the same as the embodiment shown in FIG. 4. The only difference is in the data storage apparatus 50, its locking mechanism 565 is set on the disk loading/unloading mechanism 56. The operating way is making the locking mechanism 565 embedded into the position opening 35 of the body to become a locking status before the disk loading/unloading mechanism 56 pulling the tray 321. Thereby, the stability of the following loading and the data accessing actions is ensured. After finishing data accessing, make the locking mechanism 565 to unlock the locking status after stopping accessing data and unloading the tray 321. By the structure and operating mechanism of the present embodiment, the processing method shown in FIG. 5 can also be performed, and ensuring the stability of the operations of disk loading/unloading and data accessing is achieved.

Of course, the technical feature of the structure and method of the present invention can be applied in optical disk drives and data storage apparatuses with other similar functions, and the data storage media which they used corresponds to the types of the data storage apparatus, i.e. optical disks or other corresponding data storage media. By the structure and method of the present invention, it is ensured in the process of changing disks and accessing data of the data storage apparatus, even suffering attacks or vibrations, the failures will not be caused and become a more endurable product.

In summary, the present invention relates to a data storage apparatus and a processing method thereof, and more particularly to a data storage apparatus and a processing method thereof which ensures the processing safety when changing data storage media. It not only is benefit to change multiple data storage media but also prevents failure due to vibrations.

The foregoing description is merely one embodiment of present invention and not considered as restrictive. All equivalent variations and modifications in process, method, feature, and spirit in accordance with the appended claims may be made without in any way from the scope of the invention.

1. A data storage apparatus whose main structure, comprising:
a magazine, a plurality of trays set therein capable of carrying a plurality of data storage media;
a disk loading/unloading mechanism for pulling out and unloading one of said trays of said magazine thereby loading and unloading said data storage media;
an accessing mechanism for selectively perform one of said actions of reading, writing, and one of said combination thereof to said data storage media loaded by said disk loading/unloading mechanism; and
an up-down mechanism for carrying and moving said disk loading/unloading mechanism and said accessing mechanism and capable of moving them to a position accessing said data storage media;
wherein said up-down mechanism has further a locking mechanism capable of locking and positioning said up-down mechanism when it reaches said position and then performing actions of loading disks and accessing data;
wherein said locking mechanism unlocks said locking status after accessing data and said disk loading/unloading mechanism finishes an action of unloading said disk.

2. The data storage apparatus according to claim 1, wherein said data storage apparatus is an optical disk drive.

3. The data storage apparatus according to claim 2, wherein said data storage medium is an optical disk.

4. A data storage apparatus whose main structure comprising:
a magazine, a plurality of trays set therein capable of carrying a plurality of data storage media;
a disk loading/unloading mechanism for pulling out and unloading one of said trays of said magazine thereby loading and unloading said data storage media;
an accessing mechanism for selectively perform one of said actions of reading, writing, and one of said combination thereof to said data storage media loaded by said disk loading/unloading mechanism; and
an up-down mechanism for carrying and moving said disk loading/unloading mechanism and said accessing mechanism and capable of moving them to a position accessing said data storage media;
wherein said disk loading/unloading mechanism has further a locking mechanism capable of locking and positioning said up-down mechanism when it reaches said position and then performing actions of loading disks and accessing data, wherein said locking mechanism unlocks said locking status after accessing data and said disk loading/unloading mechanism finishes an action of unloading said disk.

5. The data storage apparatus according to claim 4, wherein said data storage apparatus is an optical disk drive.

6. The data storage apparatus according to claim 5, wherein said data storage medium is an optical disk.

7. A processing method of a data storage device, wherein the main structure of said data storage apparatus comprises: a magazine using a plurality of trays to carry a plurality of data storage media, a disk loading/unloading mechanism, an accessing mechanism, an up-down mechanism, and a locking mechanism; said processing method mainly comprising the steps of:
up-down moving said disk loading/unloading mechanism by said up-down mechanism, accessing mechanism, and locking mechanism to a default position corresponding to said data storage medium to be read;
locking said up-down mechanism by said locking mechanism, accessing mechanism, and disk loading/unloading mechanism to said default position; and
pulling out a corresponding tray of said magazine to load said data storage medium by said disk loading/unloading mechanism, and using said accessing mechanism to perform one of said actions of reading, writing, and a combination thereof to said data storage medium.

8. The processing method according to claim 7, the steps further included when performing the action of unloading said disk:
stopping said accessing action of said accessing mechanism;
unloading said tray and said data storage medium by said disk loading/unloading mechanism; and
unlocking said locking status of said locking mechanism.

9. The processing method according to claim 7, the steps further included when performing the action of changing said disk:
stopping said accessing action of said accessing mechanism;
unloading said tray and said data storage medium by said disk loading/unloading mechanism;
unlocking said locking status of said locking mechanism;
up-down moving said disk loading/unloading mechanism by said up-down mechanism, accessing mechanism, and locking mechanism to a default position corresponding to the next data storage medium to be read;
locking said up-down mechanism by said locking mechanism, accessing mechanism, and disk loading/unloading mechanism to said default position; and
pulling out a corresponding tray of said magazine to load said data storage medium by said disk loading/unloading mechanism, and using said accessing mechanism to perform one of said actions of reading, writing, and a combination thereof to said data storage medium.

10. The data storage apparatus according to claim 7, wherein said data storage apparatus is an optical disk drive.

11. The data storage apparatus according to claim 10, wherein said data storage medium is an optical disk.
